(19) United States
(12) Patent Application Publication
(10) Pub. No.: US 2008/0159150 A1
(43) Pub. Date: Jul. 3, 2008

(54) Method and Apparatus for Preventing IP Datagram Fragmentation and Reassembly

(76) Inventor: Furquan Ahmed Ansari, Watchung, NJ (US)

Correspondence Address: PATTERSON & SHERIDAN, LLP/;LUCENT TECHNOLOGIES, INC, 595 SHREWSBURY AVENUE, SHREWSBURY, NJ, 07702, US

(21) Appl. No.: 11/616,988

(22) Filed: Dec. 28, 2006

(51) Int. Cl. H03K 7/08

(52) U.S. Cl. 370/238

(57) ABSTRACT

The invention includes methods for controlling transmission of a plurality of packets from a sending device to a receiving device. A first method includes determining an expected path for a packet having associated with it a packet size, determining a Media Transmission Unit (MTU) size for the expected path, and, in response to a determination that the packet size is greater than the MTU size, propagating to the sending device a message adapted to reduce packet sizes of subsequent packets to be less than or equal to the MTU size. Other methods include generating a link state advertisement (LSA) for a link including a link TLV having a sub-TVL conveying MTU information associated with the link, transmitting the LSA toward a router, receiving the LSA at the router, and updating a table entry associated with the link using the MTU information conveyed by the sub-TLV.

### FIELD OF THE INVENTION

The invention relates to the field of communication networks and, more specifically, to Internet Protocol (IP) datagram routing.

### BACKGROUND OF THE INVENTION

Internet Protocol (IP) is a network-layer protocol for routing information, in the form of IP datagrams, from a sending device to a receiving device over connectionless networks using many different transmission media. IP supports a maximum IP datagram size of 64 kilobytes; however, a much smaller limit on the size of outgoing packets, known as Maximum Transmission Unit (MTU) size, is usually imposed by the underlying transmission media. Specifically, the exact value of MTU size depends on the underlying transmission medium. When the size of an IP datagram exceeds the size limit imposed by the underlying transmission medium, the IP datagram must be fragmented into smaller IP datagram portions, known as IP datagram fragments, which satisfy the MTU size restrictions of the underlying transmission medium.

The sending device fragments the IP datagrams to form IP datagram fragments and, upon receiving the IP datagram fragments of an IP datagram, the receiving device reassembles the IP datagram from the received IP datagram fragments. IP datagram fragmentation and reassembly is a resource-intensive process typically requiring large amounts of processing resources and memory resources, as well as other associated resources. Furthermore, IP datagram fragmentation and reassembly makes it difficult to provide end-to-end hardware-based fast switching at line speed on routers in the middle of the network, primarily due to the fact that hardware-based high-speed switching modules typically forward IP datagram fragments to slow-path central processor units (CPUs) to perform the required fragmentation or reassembly. The fragmentation and reassembly of IP datagrams is described in RFC 791 and RFC 815.

Since MTU sizes typically vary across different transmission media, it is usually not possible to select an IP datagram size that will ensure that the IP datagram will not be fragmented. A process does exist, however, whereby it is possible to choose, for a given path through the network, an IP datagram size that will not lead to fragmentation. This process, which is known as Path MTU Discovery (PMD), is described in RFC 1193. Path MTU Discovery, however, does not work well. First, Path MTU Discovery is slow in adapting to changes in MTU sizes along the given path through the network. Second, Internet Control Message Protocol (ICMP) filtering by routers along the given path typically prevents error reports initiated by routers in the middle of the network from reaching the sending device, thereby rendering Path MTU Discovery useless.

### SUMMARY OF THE INVENTION

Various deficiencies in the prior art are addressed through the invention of controlling transmission of a plurality of packets from a sending device to a receiving device.

Using the present invention, MTU information is distributed throughout a network. The MTU information includes MTU sizes of links in the network. The MTU information is distributed to all routers in the network such that each router knows the MTU sizes of all links in the network. In one embodiment, MTU information may be distributed using link state advertisements (LSAs). In one embodiment, MTU information may be distributed using LSA sub-TLVs. The LSAs including MTU information may be distributed using any protocol, including Interior Gateway Protocols (IGPs) such as the Open Shortest Path First (OSPF) protocol, Intermediate-System-to-Intermediate-System (IS-IS) protocol, and the like.

A method according to one embodiment of the invention includes generating a status message, where the status message is associated with a link and includes Media Transmission Unit (MTU) information associated with the link, and transmitting the status message toward at least one router. In one embodiment, the status message is a link state advertisement (LSA) including a link TLV having a sub-TVL conveying MTU information associated with the link. A method according to one embodiment of the invention includes receiving a status message associated with a link and updating a table entry associated with the link using at least a portion of the MTU information. In one embodiment, the status message includes an LSA including a link TLV having a sub-TVL, where the sub-TLV includes the MTU information associated with the link.

The routers use path information maintained by each of the routers to determine an expected path through the routing domain. The routers use the MTU information associated with the links of the expected path to determine whether IP datagram sizes of IP datagrams violate MTU sizes of links of the expected path, in order to determine whether or not the sizes of IP datagrams should be reduced. A method according to one embodiment of the invention includes determining an expected path for a packet having associated with it a packet size, determining a Media Transmission Unit (MTU) size for the expected path, and, in response to a determination that the packet size is greater than the MTU size, propagating to the sending device a message adapted to constrain packet sizes of subsequent packets to be less than or equal to the MTU size.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a communication network;

FIG. 2 depicts a method according to one embodiment of the present invention;

FIG. 3 depicts a method according to one embodiment of the present invention;

FIG. 4 depicts a method according to one embodiment of the present invention;

FIG. 5 depicts a method according to one embodiment of the present invention;

FIG. 6 depicts a method according to one embodiment of the present invention;

FIG. 7 depicts a method according to one embodiment of the present invention;

FIG. 8 depicts a method according to one embodiment of the present invention;

FIG. 9 depicts an exemplary data structure adapted for conveying MTU information between routers; and

FIG. 10 depicts a high-level block diagram of a general-purpose computer suitable for use in performing the functions described herein.

To facilitate understanding, identical reference numerals have been used, where possible, to designate identical elements that are common to the figures.

### DETAILED DESCRIPTION OF THE INVENTION

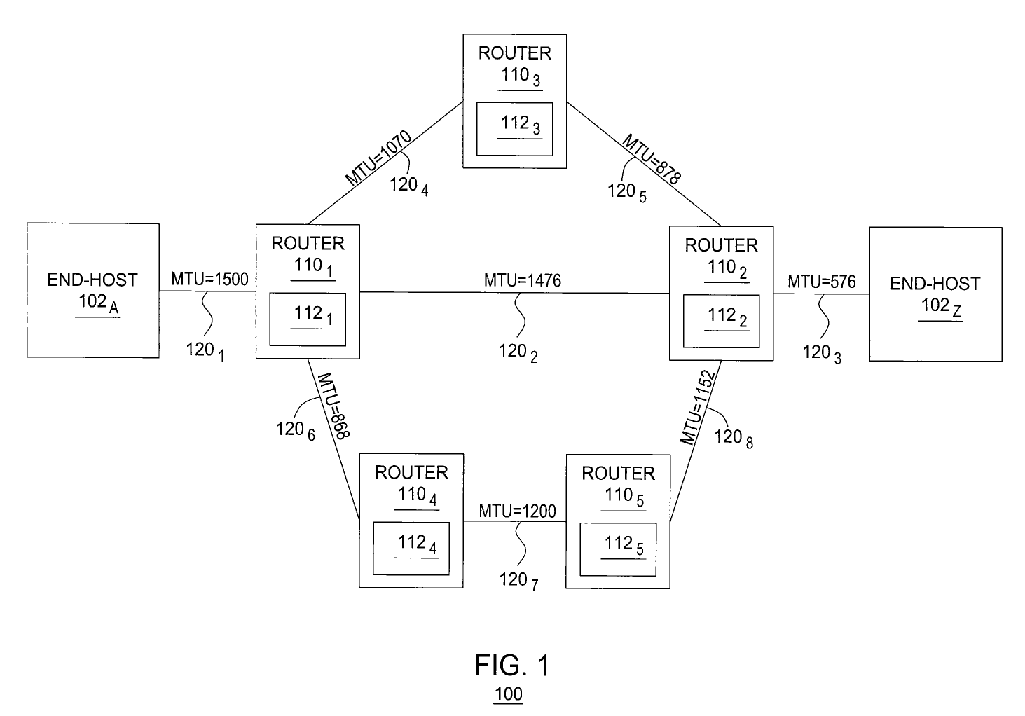

FIG. 1 depicts a high-level block diagram of a communication network. The communication network 100 is an IP-based network adapted for supporting IP-based communications (i.e., for conveying information between end-hosts using IP datagrams (or packets)). The communication network 100 may include any combination of underlying data link layer and physical layer technologies adapted for supporting IP-based communications. Specifically, communication network 100 of FIG. 1 includes a first end-host 102_{A} and a second end-host 102_{Z} (collectively, end-hosts 102) adapted for communicating using a plurality of routers 110₁-110₅ (collectively, routers 110).

The end-hosts 102 include nodes adapted for originating messages to other end-hosts 102 and terminating messages from other end-hosts 102 (i.e., each end-host 102 may operate as a sending node and/or destination node for different data flows). For example, end-hosts 102 may include end-user terminals (e.g., computers, wireline phones, wireless phones, personal data assistants, and the like), network servers (e.g., feature servers, applications servers, and the like, as well as various combinations thereof), and the like, as well as various combinations thereof. The end-hosts 102 may perform at least a portion of the functions of the present invention. The routers 110 include nodes adapted for routing packets between end-hosts 102. The routers 110 may perform at least a portion of the functions of the present invention.

The end-hosts 102 and routers 110 are interconnected by a plurality of links 120₁-120₈ (collectively, links 120). Specifically, end-host 102_{A} and router 110₁ are connected by link 120₁, router 110₁ and router 110₂ are connected by link 120₂, router 110₂ and end-host 102_{Z} and are connected by link 120₃, routers 110₁ and 110₃ are connected by link 120₄, routers 110₃ and 110₂ are connected by link 120₅, routers 110₁ and 110₄ are connected by link 120₆, routers 110₄ and 110₅ are connected by link 120₇, and routers 110₆ and 110₂ are connected by link 120₈. Although specific interconnections of routers 110 are depicted and described, various other interconnections of routers 110 may be implemented.

As depicted in FIG. 1, each link 120 has an associated MTU size. Specifically, links 120₁-120₈ have MTU sizes of 1500, 1476, 576, 1070, 898, 868, 1200, and 1208, respectively. As described herein, the MTU size of a link may depend upon the underling data link layer technology or physical layer technology by which packets are conveyed over the link. The MTU sizes of links 120 may change over time. The MTU sizes of links 120 are exchanged and distributed amongst each of the routers 110, and stored by the routers 110 for use in preventing fragmentation and reassembly of IP datagrams conveyed over communication network 100.

The routers 110₁-110₅ include a plurality of MTU tables 112₁-112₅ (collectively, MTU tables 112), respectively. The MTU tables 112 store MTU information, including MTU size information (and, thus, may also be referred to as MTU size tables). In one embodiment, MTU tables 112 store MTU information on a per-link basis. In one such embodiment, each MTU table 112 includes an entry for each link 120 in communication network 100, where the entry for a given link 120 is the MTU size for that link 120. Although primarily depicted and described as storing MTU information on a per-link basis, MTU information may be stored on routers 110 on a per-interface basis, per-router basis, and the like, as well as various combinations thereof, as well as using various other formats.

As described herein, communication network 100 is an IP-based network which may include any combination of underlying data link layer and physical layer technologies adapted for supporting IP-based communications. For purposes of clarity, communication network 100 may be assumed to be an autonomous system running an Interior Gateway Protocol (IGP) for exchanging information between routers 110. The Interior Gateway Protocol utilized in communication network 100 may include one or more of Open Shortest Path First (OSPF), Intermediate System to Intermediate System (IS-IS), and the like, as well as various combinations thereof. The information exchanged between routers 110 may include routing information, traffic engineering information, and the like, as well as various combinations thereof.

In one embodiment, as described herein, traffic engineering information may include MTU information, including MTU size information. In one embodiment, MTU sizes of links 120 may be communicated to each of the routers 110 periodically. In one embodiment, MTU sizes of links 120 may be communicated to each of the routers 110 when the MTU sizes of links 120 change. In one such embodiment, MTU sizes of links 120 may be communicated to each of the routers 110 each time the MTU size of one of the links 120 changes. In another such embodiment, MTU sizes of links 120 may be communicated to each of the routers 110 each time the MTU size of one of the links 120 changes by more than a threshold amount (e.g., by more than 5%, more than 10%, more than 200, and the like). Upon receiving MTU size information, routers 110₁-110₅ updated MTU tables 112₁-112₅, respectively.

Although communication network 100 is depicted and described herein with respect to specific numbers and configurations of end-hosts 102, routers 110, and links 120, communication network 100 may include various other numbers and combinations of end-hosts 102, routers 110, and links 120. Although only two routers are depicted and described herein as operating as network ingress/egress points for end-hosts (illustratively, routers 110₁ for end-host 102_{A} and 110₂ for end-host 102_{Z}), each router 110 may function as a network ingress and/or egress point for one or more end-hosts (omitted for purposes of clarity).

The general operation of communication network 100 in conveying messages between end-hosts 102 may be better understood with respect to the following example. In this example, assume end-host 102_{A} creates a message intended for end-host 102_{Z}. The end-host 102_{A} segments the message into a plurality of IP datagrams for transmission to router 110₁. The end-host 102_{A} transmits the IP datagrams to router 110₁. The router 110₁ determines a next-hop for each IP datagram using a routing table. In this example, assume that router 110₁ determines that router 110₂ is the next hop for each IP datagram. The router 110₁ forwards each IP datagram to router 110₂. Upon receiving IP datagrams of the message, router 110₂ delivers the IP datagrams to end-host 102_{Z}. The end-host 110₂ reconstructs the message from the IP datagrams.

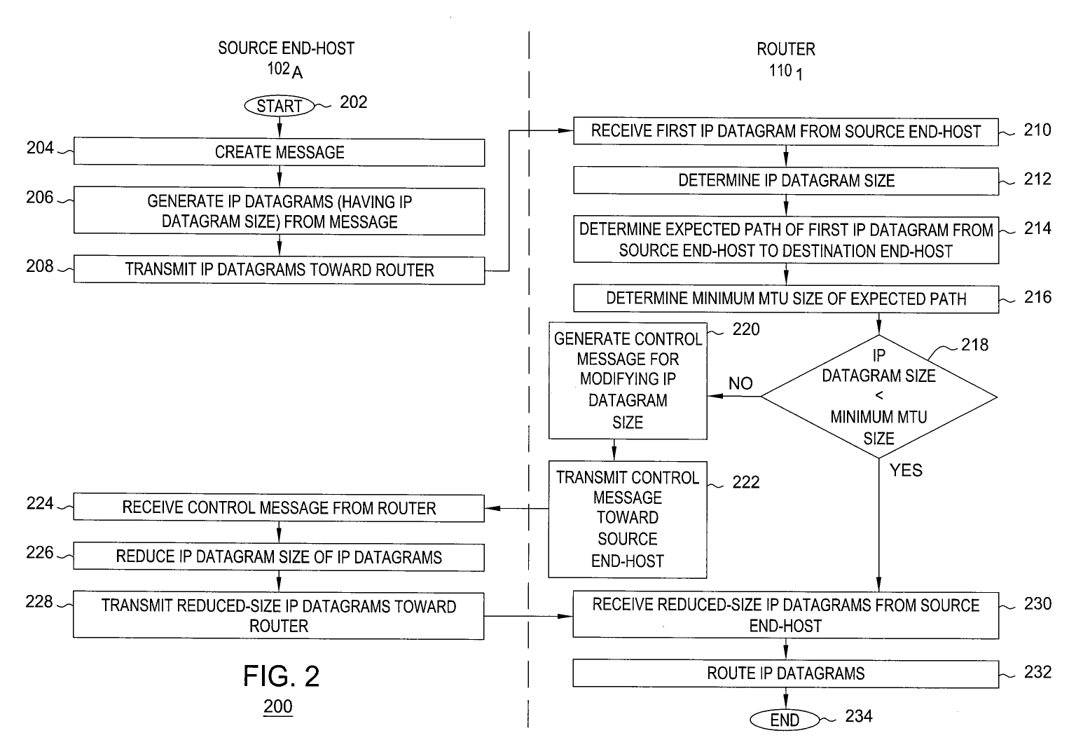

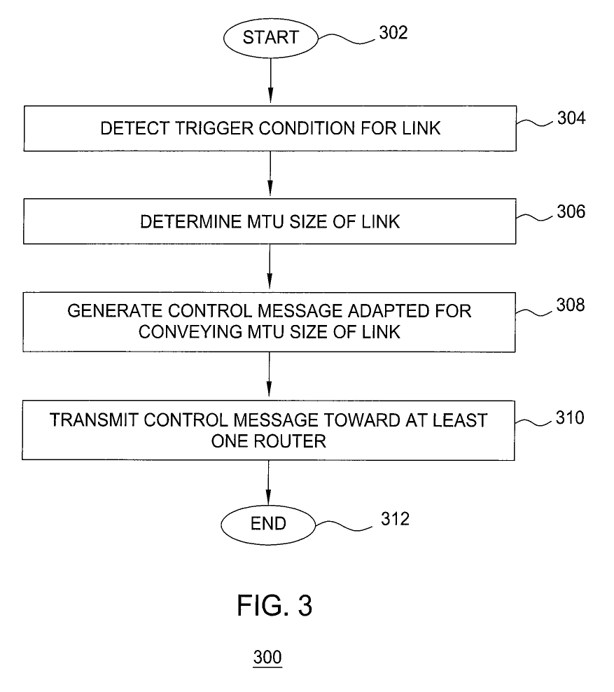

As described herein, in existing networks, if an IP datagram received by router 110₁ is larger than the MTU size associated with link 120₁ on which the IP datagram is transmitted to router 110₂, router 110₁ must fragment the IP datagram into a plurality of packets for transmission to router 110₂ and router 110₂ must reassemble the IP datagram from the plurality of fragmented packets. Using the present invention, in order to avoid IP datagram fragmentation (by router 110₁) and reassembly (by router 110₂), router 110₁ performs additional processing to ensure that IP datagrams received from host 102_{A} have associated packet sizes that are less than or equal to a minimum MTU size associated with a path that the IP datagrams are expected to take through the network, as depicted and described herein with respect to FIG. 2 and FIG. 3.

This additional processing (i.e., to ensure that IP datagrams received from host 102_{A} have associated packet sizes that are less than or equal to a minimum MTU size associated with a path that the IP datagrams are expected to take through the network) requires exchanging of MTU information (in particular, MTU size information) between routers 110. The exchanging of MTU information between routers 110 may be implemented using various different methods, each of which may utilize one or more associated information exchange protocols, as depicted and described herein with respect to FIGS. 3-8. Although primarily depicted and described herein with respect to specific information exchange protocols, MTU information may be distributed within communication network 100 using various other protocols.

The MTU size information may be distributed within communication network 100 using one or more protocols. In one embodiment, MTU size information may be distributed within communication network 100 using one or more link state protocols, traffic engineering information distribution protocols, and the like, as well as various combinations thereof. In one such embodiment, MTU size information may be distributed within communication network 100 using one or more Interior Gateway Protocols (IGPs), such as Routing Information Protocol (RIP), Open Shortest Path First (OSPF), Intermediate-System-to-Intermediate-System (IS-IS), and the like, as well as various combinations thereof. For purposes of clarity, distribution of MTU size information is primarily described herein with respect to OSPF.

In one embodiment, MTU information is distributed using OSPF traffic engineering (TE) messages, such as opaque link state advertisements (LSAs). An LSA includes an LSA header and an LSA payload. The LSA header includes LSA routing information for routing the LSA to one or more routers to which the LSA is intended to be delivered. The LSA payload includes one top level TLV. In one embodiment, since MTU information is associated with a link, the one top level TLV included in the LSA payload is a link TLV (although it should be noted that the existing router address TLV may be adapted to convey MTU information, or one or more new top level TLVs may be defined to convey MTU information).

A single link TLV is included within each LSA. The link TLV is a link TLV type 2, variable in length, and describes a single link. The link TLV includes at least one sub-TLV. There are no ordering requirements for sub-TLVs within a link TLV. The following sub-TLVs of the link TLV have been defined (in RFC 3630): link type (type 1; 1 octet), link identifier (type 2; 4 octets), local interface IP address (type 3; 4 octets), remote interface IP address (type 4; 4 octets), traffic engineering metric (type 5; 4 octets), maximum bandwidth (type 6; 4 octets), maximum reservable bandwidth (type 7; 4 octets), unreserved bandwidth (type 8; 32 octets), and administrative group (type 9; 4 octets).

In one embodiment, MTU information may be conveyed within a link TLV of an LSA. In one such embodiment, MTU information may be conveyed within a link TLV of an LSA using at least one sub-TLV. In one embodiment, the MTU sub-TLV is implemented using an existing sub-TLV (i.e., one or more of sub-TLV type 1 through sub-TLV type 9 described herein and described in RFC 3630 in additional detail). In one such embodiment, an unused portion of one of the existing sub-TLVs may be used for conveying the MTU size, or a portion of one of the existing sub-TLVs may be modified for use in conveying the MTU size.

In one embodiment, MTU information may be conveyed within a link TLV of an LSA using a newly defined sub-TLV (i.e., a sub-TLV having a type other than type 1 through type 9). For purposes of clarity, the newly-defined sub-TLV adapted for carrying MTU information is referred to herein as a sub-TLV type 10; however, it should be noted that, should a newly defined sub-TLV be standardized, the sub-TLV may be labeled using an identifier other than type 10. For example, if sub-TLV type 10 is standardized for a purpose other than conveying MTU information, the newly-defined sub-TLV adapted for carrying MTU information may be standardizes as a sub-TLV type 11, and so on.

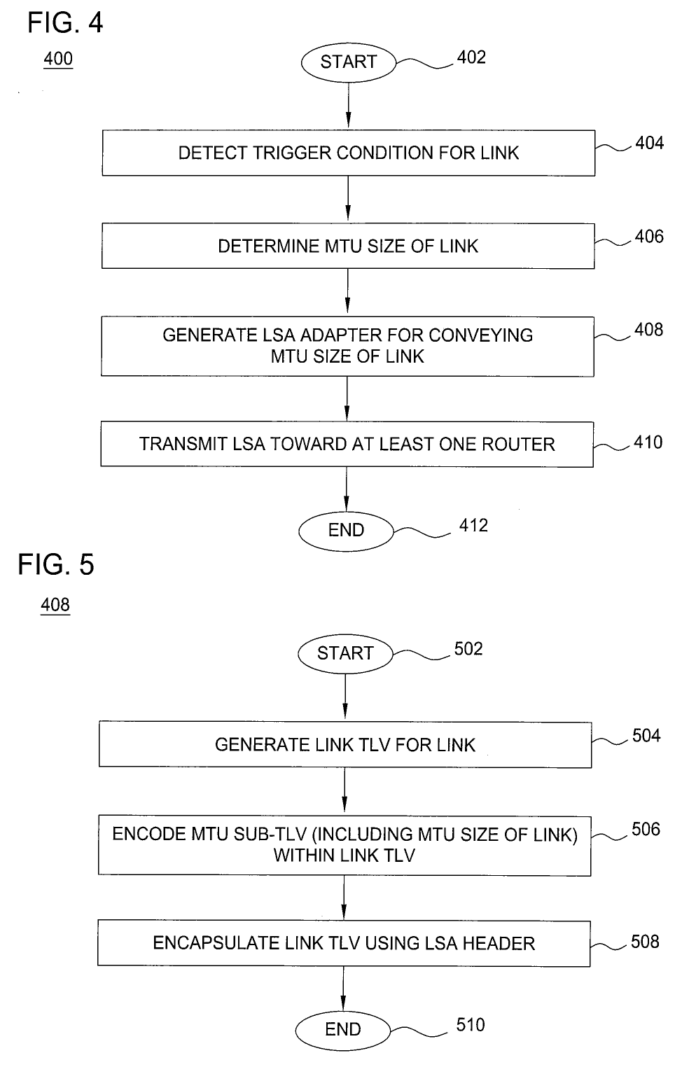

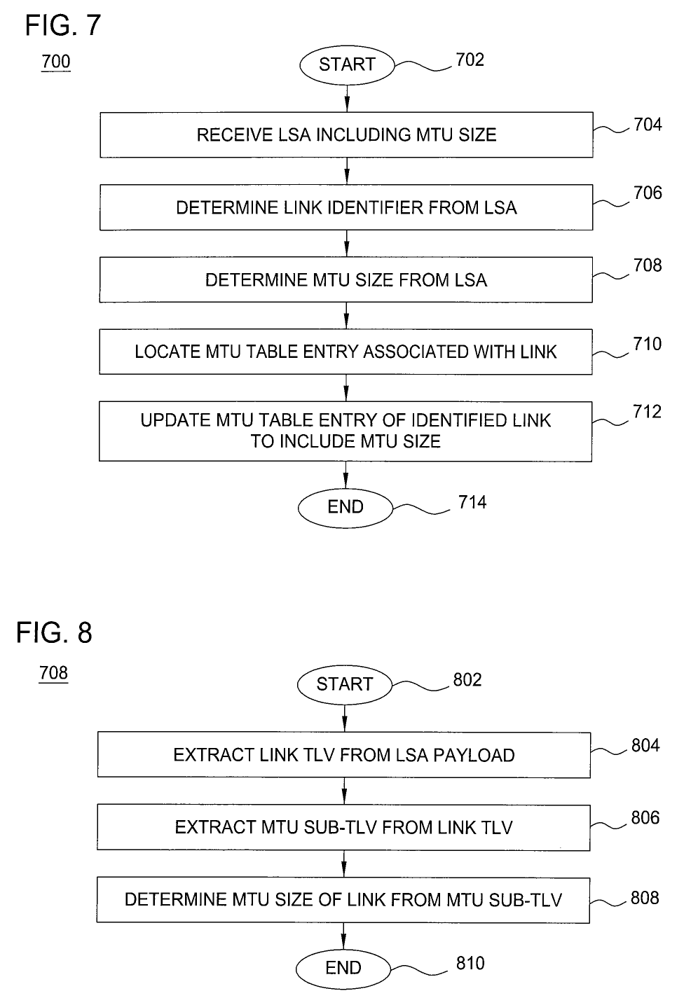

In one embodiment, the newly defined sub-TLV type 10 is 4 octets; however, it should be noted that in other embodiments the sub-TLV that is used to convey MTU information may use fewer or more octets to convey MTU information between routers. In this embodiment, the 4 octets of the sub-TLV may include one TYPE octet, one LENGTH octet, and two VALUE octets. The distribution of MTU information, including MTU size information, using an LSA including a link TLV having at least one sub-TLV, may be better understood with respect to FIGS. 4-5 (which describe generating and transmitting of an LSA adapted for conveying MTU information) and FIGS. 7-8 (which describe receiving and processing an LSA adapted for conveying MTU information), as depicted and described herein.

FIG. 2 depicts a method according to one embodiment of the present invention. Specifically, method 200 of FIG. 2 includes a method for ensuring that an IP datagrams size of IP datagrams intended for transmission from a source end-host to a destination end-host is less than or equal to a minimum MTU size of an expected path from the source end-host to the destination end-host. Although depicted and described as being performed serially, at least a portion of the steps of method 200 of FIG. 2 may be performed contemporaneously, or in a different order than depicted in FIG. 2. The method 200 begins at step 202 and proceeds to step 204.

At step 204, a source end-host creates a message intended for delivery to a destination end-host (or generates some information intended for delivery to a destination end-host). At step 206, the source end-host generates IP datagrams from the created message (i.e., segments the message into IP datagrams). The IP datagrams have an associated IP datagram size. At step 208, the source end-host begins transmitting the IP datagrams toward a router. The source-end host begins transmitting the IP datagrams toward an access router by which the source end-host accesses the communication network. The source end-host begins by transmitting a first IP datagram toward the router.

At step 210, the router receives the first IP datagram from the end-host. At step 212, the router determines the IP datagram size of the first IP datagram. At step 214, the router determines an expected path of the first IP datagram from the source end-host to the destination end-host. In one embodiment, the expected path is the shortest path from source end-host to destination end-host. In one such embodiment, the shortest path is determined using shortest path tree calculations. Although there is no guarantee that the expected path determined by the access router is the path actually followed by the IP datagrams, the expected path determined by the access router is a very good estimate of the actual path followed by the IP datagrams because all core routers in the communication network will be using the same routing tables to route the IP datagrams from the access router to the destination end-host.

At step 216, the router determines a minimum MTU size of the expected path. In one embodiment, the minimum MTU size of the expected path is determined by identifying each link of the expected path, determining, for each identified link of the expected path, an MTU size of the identified link, and determining the minimum MTU size from the MTU sizes of the identified links of the expected path. In one embodiment, the MTU size of an identified link is determined by querying an MTU table using a link identifier of the identified link. The MTU table is updating as depicted and described herein with respect to FIG. 3-FIG. 8.

At step 218, a determination is made as to whether the IP datagram size of the first IP datagram is greater than the minimum MTU size of the expected path from the source end-host to the destination end-host. If the IP datagram size of the first IP datagram is greater than the minimum MTU size of the expected path from the source end-host to the destination end-host, method 200 proceeds to step 220. If the IP datagram size of the first IP datagram is not greater than the minimum MTU size of the expected path from the source end-host to the destination end-host, method 200 proceeds to step 230. At step 230, the router routes the first IP datagram toward the destination end-host. From step 230, method 200 proceeds to step 232. At step 232, the router receives other IP datagrams from the source end-host. From step 232, method 200 proceeds to step 234. At step 234, the router routes the other IP datagrams toward the destination end-host. From step 234, method 200 proceeds to step 236, where method 200 ends.

At step 220, the router generates a control message adapted for modifying the IP datagram size of the IP datagrams generated from the created message. In one embodiment, the control message may include the minimum MTU size associated with the expected path (for use by the source end-host to reduce the IP datagram size to be less than or equal to the minimum MTU size). In one embodiment, the control message may include a new IP datagram size that is less than or equal to the minimum MTU size associated with the expected path (for use by the source end-host to reduce the IP datagram size to be equal to the new IP datagram size). In one embodiment, the control message is an Internet Control Message Protocol (ICMP) message. At step 222, the router transmits the control message toward the source end-host.

At step 224, the source end-host receives the control message. At step 226, the source end-host reduces the IP datagram size of the IP datagrams generated from the created message. In one embodiment, in which the control message includes the minimum MTU size, the source end-host uses the minimum MTU size received in the control message to reduce the IP datagram size of the IP datagrams (for that message) to be less than or equal to the minimum MTU size. In one embodiment, in which the control message includes the new IP datagram size, the source end-host uses the new IP datagram size received in the control message to reduce the IP datagram size of the IP datagrams (for that message) to be equal to the new IP datagram size.

At step 228, the source end-host begins transmitting the reduced-size IP datagrams toward the router. At step 232, the router receives the reduced-size IP datagrams from the source end-host. In one embodiment, since this is the second time that the router has received an IP datagram from that source end-host intended for that destination end-host (and, optionally, also for that specific message), the router is not required to re-execute steps 210-222. From step 232, method 200 proceeds to step 234. At step 234, the router routes the reduced-size IP datagrams toward the destination end-host. From step 234, method 200 proceeds to step 236, where method 200 ends.

In one embodiment, the first IP datagram of the message (i.e., the IP datagram that was used by the router to determine that the sizes of the IP datagrams needed to be reduced) is retransmitted by the source end-host. In one embodiment, the first IP datagram of the message is not retransmitted by the source end-host (i.e., the second IP datagram of the message is the first IP datagram transmitted by the source end-host using the reduced size. In this embodiment, the router may either perform fragmentation of the first IP datagram of the message (and reassembly will be performed at the receiving end), or the router may simply drop the first IP datagram and leave it up to the destination end-host to determine whether or not to request retransmission of the first IP datagram (which would be retransmitted using the reduced size). For example, if the destination end-host uses TCP, the source end-host will retransmit the IP datagram if it is not received by the destination end-host.

The method 200 of FIG. 2 may be better understood with respect to an example. In one such example, with respect to FIG. 1, assume that end-host 102_{A} is the source end-host and end-host 102_{Z} is the destination end-host. The source end-host 102_{A} creates a message intended for delivery to destination end-host 102_{Z}, and generates multiple IP datagrams from the created message (i.e., segments the message into IP datagrams). In this example, assume that the IP datagrams size of each IP datagram is 2000 bytes. The source end-host 102_{A} begins transmitting the IP datagrams toward an access router by which source end-host 102_{A} accesses the communication network (illustratively, router 110₁). The source end-host 102_{A} transmits a first IP datagram toward router 110₁).

The router 110₁ receives the first IP datagram from source end-host 102_{A}. The router 110₁ determines the IP datagram size of the first IP datagram (which is 2000 bytes). The router 110₁ determines an expected path of the first IP datagram from source end-host 102_{A} to destination end-host 102_{Z}. Using a shortest path calculation, assume that router 110₁ determines that the expected path from source end-host 102_{A} to destination end-host 102_{Z} is the path from source end-host 102_{A} to router 110₁, to router 110₁, to destination end-host 102_{Z}.

The router 110₁ determines a minimum MTU size for the expected path. In order to determine the minimum MTU size for the expected path, router 110₁ identifies the links of the expected path. As depicted in FIG. 1, the links of the determined expected path include links 120₁, 120₂, and 120₃. The router 110₁ determines an MTU size for each of the identified links of the expected path. In one embodiment, the MTU size of an identified link is determined by querying an MTU table maintained by router 110₁. As depicted in FIG. 1, the MTU sizes of links 120₁, 120₂, and 120₃ of the determined expected path include 1500, 1476, and 576, respectively. The router determines the minimum MTU size from the MTU sizes of the identified links of the expected path. In this example, the minimum MTU size is 576.

The router 110₁ determines whether the IP datagram size of the first IP datagram is greater than the minimum MTU size of the expected path from the source end-host to the destination end-host. In this example, the IP datagram size of the first IP datagram (2000 bytes) is greater than the minimum MTU size of the expected path from the source end-host to the destination end-host (576 bytes). The router 110₁ generates an ICMP message adapted for modifying the IP datagram size of the IP datagrams. The router 110₁ transmits the ICMP message to source end-host 102_{A}. The source end-host 102_{A} receives the ICMP message from router 110₁. The source end-host 102_{A}, in response to the ICMP message from router 110₁, reduces the IP datagram size of the IP datagrams and transmits the reduced-size IP datagrams to router 110₁. The router 110₁ receives the reduced-size IP datagrams from source-host 110₁ and routers the reduced-size IP datagrams toward destination end-host 102_{Z}. Upon receiving the reduced-size IP datagrams, destination end-host 102_{Z} reassembles the message created by source end-host 102_{A}.

Although primarily depicted and described herein with respect to an embodiment in which all IP datagrams associated with a message are generated before the first IP datagram is transmitted to an access router, in other embodiments, a first IP datagram may be generated and transmitted to an access router before the remaining IP datagrams are generated from the message. In one such embodiment, if the MTU size of the expected path is determined to be smaller than the size of the first IP datagram generated and sent to the access router, then the control message sent from the router to the sending device may be adapted to constrain the remaining IP datagrams to be less than or equal to the MTU size of the expected path (i.e., since the other IP datagrams have not yet been generated, those IP datagrams are not reduced in size, rather, they are constrained such that, when generated, they do not violate the MTU size of the expected path).

FIG. 3 depicts a method according to one embodiment of the present invention. Specifically, method 300 of FIG. 3 includes a method for distributing MTU size information, including an MTU size of a link, to a router. Although depicted and described as distributing MTU size information to one router, MTU size information is typically sent to all routers in the communication network (or at least to each router operating as an access router). The method 300 of FIG. 3 is applicable to various protocols, such as RIP, OSPF, IS-IS, and the like. Although depicted and described as being performed serially, at least a portion of the steps of method 300 of FIG. 3 may be performed contemporaneously, or in a different order than depicted in FIG. 3. The method 300 begins at step 302 and proceeds to step 304.

At step 304, a trigger condition is detected. The trigger condition is detected for a link. In one embodiment, the trigger condition is a periodic trigger condition (e.g., a certain length of time has passed since the MTU size of the link has been communicated to other routers of the communication network). In one embodiment, the trigger condition is an event-based trigger condition (e.g., the MTU size of the link crosses a threshold, changes by more than a threshold amount, and the like). At step 306, the MTU size of the link is determined.

At step 308, a control message adapted for conveying the determined MTU size of the link is generated. In one embodiment, the control message includes a link identifier of the link and the associated MTU size. The format of the control message depends on the protocol employed to distribute the control message (e.g., RIP, OSPF, IS-IS, and the like). At step 310, the control message is transmitted toward at least one router. In one embodiment, the control message is transmitted toward all other routers in the communication network. In another embodiment, the control message is transmitted toward a subset of the other routers in the network (e.g., only those routers operating as access routers). At step 312, method 300 ends.

The generation and transmission of the control message may be better understood with respect to FIG. 4 and FIG. 5, which describe embodiments for generation and transmission of a control message adapted for conveying MTU size information in a communication network employing OSPF for routing IP datagrams and distributing routing and traffic engineering information. Although primarily depicted and described herein with respect to OSPF, embodiments for generation and transmission of a control message adapted for conveying MTU size information in a communication network employing other IGPs (e.g., RIP, IS-IS, and the like) may be used in accordance with the present invention.

FIG. 4 depicts a method according to one embodiment of the present invention. Specifically, method 400 of FIG. 4 includes a method for generating an OSPF link state advertisement intended for delivery to a router, where the link state advertisement conveys MTU information, including MTU size information. Although primarily depicted and described with respect to OSPF, method 400 of FIG. 4 may be adapted for use with various other protocols which may be employed within a communication network for distributing routing information and traffic engineering information, such as RIP, IS-IS, and the like. Although depicted and described as being performed serially, at least a portion of the steps of method 400 of FIG. 4 may be performed contemporaneously, or in a different order than depicted in FIG. 4. The method 400 begins at step 402 and proceeds to step 404.

At step 404, a trigger condition is detected. The trigger condition is detected for a link. The trigger condition may be a periodic trigger condition, an event-based trigger condition, and the like. At step 406, the MTU size of the link is determined. At step 408, a link state advertisement (LSA) adapted for conveying the determined MTU size of the link is generated. As described herein, the LSA includes an LSA header and an LSA payload. The generation of the LSA adapted for conveying the determined MTU size of the link is depicted herein with respect to FIG. 5. At step 410, the LSA is transmitted toward at least one router. In one embodiment, the LSA is transmitted toward all other routers in the communication network. In another embodiment, the LSA is transmitted toward a subset of the other routers in the network (e.g., only routers operating as access routers). At step 412, method 400 ends.

FIG. 5 depicts a method according to one embodiment of the present invention. Specifically, method 408 of FIG. 5 includes a method for generating an OSPF link state advertisement adapted for conveying MTU information, including MTU size information. Although primarily depicted and described with respect to OSPF, method 408 of FIG. 5 may be adapted for use with various other protocols, such as RIP, IS-IS, and the like. Although depicted and described as being performed serially, at least a portion of the steps of method 408 of FIG. 5 may be performed contemporaneously, or in a different order than depicted in FIG. 5. The method 408 begins at step 502 and proceeds to step 504.

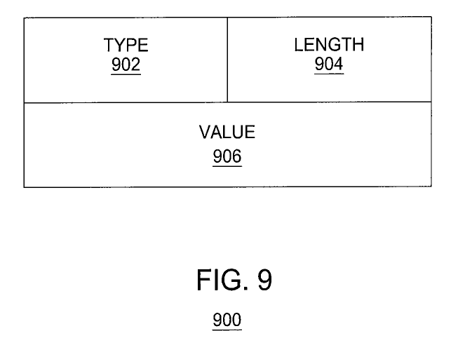

At step 504, a link TLV is generated for the link. At step 506, an MTU sub-TLV is encoded within the link TLV. The MTU sub-TLV includes the MTU size of the link. In one embodiment, the MTU sub-TLV is implemented using an existing sub-TLV (i.e., one or more of sub-TLV type 1 through sub-TLV type 9). In this embodiment, an unused portion of one of the existing sub-TLVs may be used for conveying the MTU size, or a portion of one of the existing sub-TLVs may be modified for use in also conveying the MTU size. In one embodiment, the MTU sub-TLV is a newly-defined sub-TLV (e.g., newly-defined sub-TLV type 10, an example of which is depicted and described herein with respect to FIG. 9). At step 508, the link TLV (including the MTU sub-TLV encoded within the link TLV) is encapsulated by an LSA header, thereby forming an LSA adapted for conveying the MTU size of the link. At step 510, method 408 ends.

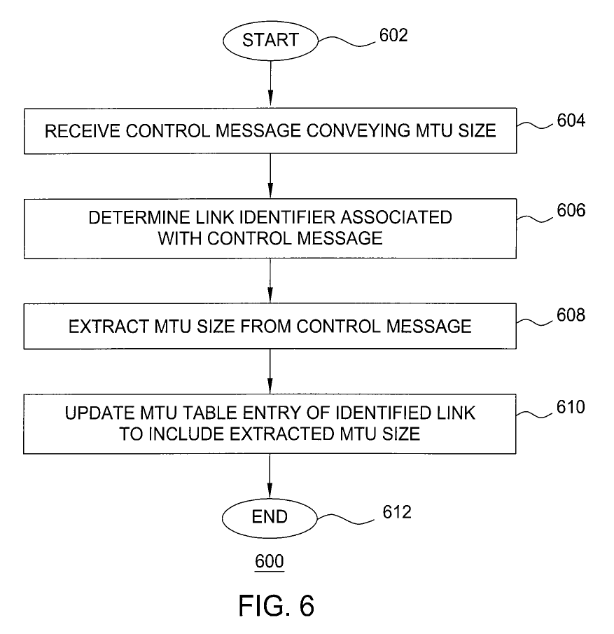

FIG. 6 depicts a method according to one embodiment of the present invention. Specifically, method 600 of FIG. 6 includes a method for receiving and processing a control message conveying MTU information, including MTU size information, for updating an MTU table. The method 600 of FIG. 6 is applicable to various protocols, such as RIP, OSPF, IS-IS, and like protocols. Although depicted and described as being performed serially, at least a portion of the steps of method 600 of FIG. 6 may be performed contemporaneously, or in a different order than depicted in FIG. 6. The method 600 begins at step 602 and proceeds to step 604.

At step 604, a control message is received. The received control message identifies a link and includes the MTU size of the identified link. At step 606, the link associated with the control message is determined. At step 608, the MTU size associated with the link is extracted from the control message. At step 610, an MTU table entry associated with the identified link is updated to include the MTU size conveyed by the control message. In one embodiment, in which the MTU table is indexed using link identifiers, the MTU table entry is identified using the link identifier conveyed by the control message. At step 612, method 600 ends.

The reception and processing of the control message may be better understood with respect to FIG. 6, which describes an embodiment for reception and processing of a control message conveying MTU size information in a communication network employing OSPF for routing IP datagrams and distributing routing and traffic engineering information. Although primarily depicted and described herein with respect to OSPF, embodiments for reception and processing of a control message adapted for conveying MTU size information in a communication network employing other IGPs (e.g., RIP, IS-IS, and the like) may be used in accordance with the present invention.

FIG. 7 depicts a method according to one embodiment of the present invention. Specifically, method 700 of FIG. 7 includes a method for receiving and processing an OSPF link state advertisement conveying MTU information, including MTU size information, for updating an MTU table.

Although primarily depicted and described with respect to OSPF, method 700 of FIG. 7 may be adapted for use with various other protocols, such as RIP, IS-IS, and the like. Although depicted and described as being performed serially, at least a portion of the steps of method 700 of FIG. 7 may be performed contemporaneously, or in a different order than depicted in FIG. 7. The method 700 begins at step 702 and proceeds to step 704.

At step 704, a LSA is received. The LSA includes an LSA header and an LSA payload. The LSA includes a link identifier and an MTU size of the link. At step 706, the link is determined from the LSA (e.g., the link identifier of the link is determined from the LSA). At step 708, the MTU size of the link is determined from the LSA. The determination of the MTU size from the LSA is depicted and described herein with respect to FIG. 8. At step 710, the MTU table entry associated with the link is located (e.g., using the link identifier of the link, from step 706). At step 712, the MTU table entry corresponding to the link is updated. The MTU table entry is updated to include the MTU size received in the LSA. At step 714, method 700 ends.

FIG. 8 depicts a method according to one embodiment of the present invention. Specifically, method 708 of FIG. 8 includes a method for extracting an MTU size of a link from an OSPF link state advertisement. Although primarily depicted and described with respect to OSPF, method 708 of FIG. 8 may be adapted for use with various other protocols, such as RIP, IS-IS, and the like. Although depicted and described as being performed serially, at least a portion of the steps of method 708 of FIG. 8 may be performed contemporaneously, or in a different order than depicted in FIG. 8. The method 708 begins at step 802 and proceeds to step 804.

At step 804, a link TLV is extracted from the LSA payload of the LSA. At step 806, an MTU sub-TLV is extracted from the link TLV. The MTU sub-TLV includes the MTU size of the link. In one embodiment, the MTU sub-TLV is implemented using an existing sub-TLV (i.e., one or more of sub-TLV type 1 through sub-TLV type 9). In this embodiment, an unused portion of one of the existing sub-TLVs may be used for conveying the MTU size, or a portion of one of the existing sub-TLVs may be modified for use in also conveying the MTU size. In one embodiment, the MTU sub-TLV is a newly-defined sub-TLV (e.g., newly-defined sub-TLV type 10, an example of which is depicted and described herein with respect to FIG. 9). At step 808, the MTU size of the link is determined from the MTU sub-TLV. At step 810, method 708 ends.

FIG. 9 depicts an exemplary data structure adapted for conveying MTU information between routers. Specifically, data structure 900 is an MTU sub-TLV adapted for inclusion within a link TLV of an OSPF LSA. As depicted in FIG. 9, data structure 900 includes a TYPE field 902, a LENGTH field 904, and a VALUE field 906. The TYPE field 902 is one octet. The LENGTH field 904 is one octet. The VALUE field 906 is two octets. As described herein, as of this writing, Applicant proposes a newly-defined sub-TLV type 10 (although it should be noted that, should this newly defined sub-TLV be standardized, the sub-TLV may be labeled using an identifier other than type 10, depending on the number of intervening standardized sub-TLV types).

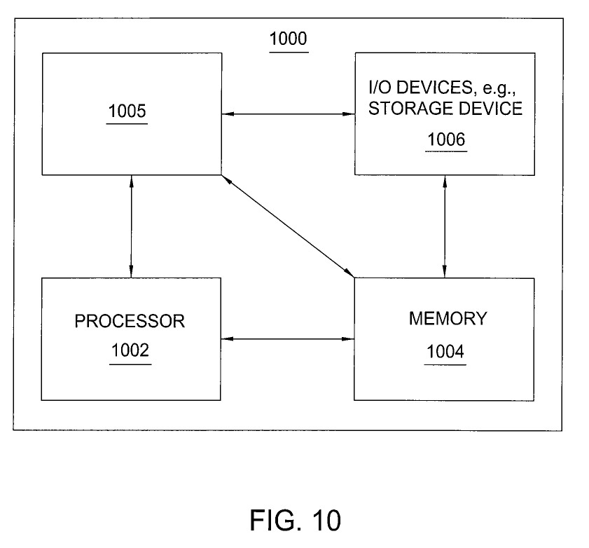

FIG. 10 depicts a high-level block diagram of a general-purpose computer suitable for use in performing the functions described herein. As depicted in FIG. 9, system 900 comprises a processor element 902 (e.g., a CPU), a memory 904, e.g., random access memory (RAM) and/or read only memory (ROM), an MTU size processing module 905, and various input/output devices 906 (e.g., storage devices, including but not limited to, a tape drive, a floppy drive, a hard disk drive or a compact disk drive, a receiver, a transmitter, a speaker, a display, an output port, and a user input device (such as a keyboard, a keypad, a mouse, and the like)).

It should be noted that the present invention may be implemented in software and/or in a combination of software and hardware, e.g., using application specific integrated circuits (ASIC), a general purpose computer or any other hardware equivalents. In one embodiment, the present MTU size process 905 can be loaded into memory 904 and executed by processor 902 to implement the functions as discussed above. As such, MTU size process 905 (including associated data structures) of the present invention can be stored on a computer readable medium or carrier, e.g., RAM memory, magnetic or optical drive or diskette and the like.

Although primarily depicted and described herein with respect to a specific network architecture, specific algorithms for determining an expected path, specific protocols and messages for conveying control messages adapted for reducing IP datagram size, and specific protocols, messages, and message formats for conveying MTU size information between routers, those skilled in the art will appreciate that the present invention may be used to prevent IP datagram fragmentation and reassembly in various other network architectures using various other algorithms for determining an expected path, various other protocols and messages for conveying control messages adapted for reducing IP datagram size, and various other protocols, messages, and message formats for conveying MTU size information between routers.

Although primarily depicted and described herein with respect to embodiments in which the sending device and receiving device are end-hosts (e.g., end user terminals such as computers, phones, and the like), in other embodiment, one or both of the sending device and the receiving device for the purposes of the present invention may be a router or other network element. For example, in one embodiment in which IP datagrams transmitted from a source device and intended for a destination device must traverse multiple routing domains, if each routing domain is independently performing the present invention, edge-routers between the different routing domains may operate as the sending device and receiving device for purposes of constraining IP datagram size within the routing domains to be less than or equal to the minimum MTU size for the expected path of the IP datagrams through that routing domain.

Although various embodiments which incorporate the teachings of the present invention have been shown and described in detail herein, those skilled in the art can readily devise many other varied embodiments that still incorporate these teachings.

What is claimed is:

1. A method for controlling transmission of a plurality of packets from a sending device to a receiving device, comprising:
determining an expected path for a packet having associated with it a packet size;
determining a Media Transmission Unit (MTU) size for the expected path; and
in response to a determination that the packet size is greater than the MTU size, propagating to the sending device a message adapted to constrain packet sizes of subsequent packets to be less than or equal to the MTU size.

2. The method of claim 1, wherein the expected path comprises a shortest path from the sending device to the receiving device.

3. The method of claim 1, wherein the MTU size comprises a minimum MTU size associated with one of a plurality of links of the expected path.

4. The method of claim 1, wherein the MTU size is determined using an MTU size table.

5. The method of claim 4, wherein the MTU size table is updated using at least one protocol.

6. The method of claim 5, wherein the at least one protocol comprises an Interior Gateway Protocol (IGP).

7. The method of claim 4, wherein the MTU size table is updated using an Open Shortest Path First (OSPF) link state advertisement (LSA) message associated with a link.

8. The method of claim 7, wherein the LSA message comprises a link TLV, wherein the link TLV comprises a sub-TVL, wherein the sub-TLV comprises Media Transmission Unit (MTU) information associated with the link.

9. The method of claim 7, wherein the sub-TLV comprises a sub-TLV type 10.

10. The method of claim 1, wherein the message comprises an Internet Control Message Protocol (ICMP) message.

11. A method, comprising:
generating a status message, wherein the status message is associated with a link, wherein the status message includes Media Transmission Unit (MTU) information associated with the link; and
transmitting the status message toward at least one router.

12. The method of claim 11, wherein generating the status message comprises:
generating a link state advertisement (LSA) for the link, wherein the LSA comprises a link TLV, wherein the link TLV comprises a sub-TVL including the MTU information associated with the link.

13. The method of claim 11, wherein generating the LSA comprises:
generating the link TLV for the link;
encoding the sub-TLV within the link TLV; and
forming the LSA by encapsulating the link TLV using an LSA header.

14. The method of claim 11, wherein the MTU information associated with the link comprises an MTU size associated with the link.

15. The method of claim 11, wherein the sub-TLV comprises a sub-TLV type 10.

16. A method, comprising:
receiving a status message, wherein the status message is associated with a link, wherein the status message includes Media Transmission Unit (MTU) information associated with the link;
updating a table entry associated with the link using at least a portion of the MTU information conveyed by the status message.

17. The method of claim 16, wherein the status message comprises a link state advertisement (LSA), wherein the LSA comprises a link TLV associated with a link, wherein the link TLV comprises a sub-TLV, wherein the sub-TLV comprises the MTU information associated with the link.

18. The method of claim 17, wherein updating the table entry comprises:
identifying the table entry using a link identifier associated with the link;
determining an MTU size of the link from the MTU information; and
updating the table entry to include the MTU size.

19. The method of claim 16, wherein the MTU information associated with the link comprises an MTU size associated with the link.

20. The method of claim 16, further comprising:
determining an expected path for a received packet having a packet size;
determining a Media Transmission Unit (MTU) size for the expected path; and
in response to a determination that the packet size is greater than the MTU size, propagating to the sending device a message adapted to constrain packet sizes of subsequent packets to be less than or equal to the MTU size.
